(19) United States
(12) Patent Application Publication
(10) Pub. No.: US 2007/0084324 A1
(43) Pub. Date: Apr. 19, 2007

(54) Slicer for circular formed bakery products

(76) Inventor: Julio Aguero Aguilar, Provincia de Lima (PE)

Correspondence Address: FISH & RICHARDSON P.C., P.O. BOX 1022, MINNEAPOLIS, MN, 55440-1022, US

(21) Appl. No.: 11/511,863

(22) Filed: Aug. 29, 2006

(30) Foreign Application Priority Data
Aug. 30, 2005 (MX) PA/A/2005/009223

(51) Int. Cl. B23D 33/02

(52) U.S. Cl. 83/472; 83/477; 83/932

(57) ABSTRACT

Described herein is an automated bakery product slicer including a supporting structure, a sliding base plate, a rotatable dish, and a slicing mechanism. The bakery product slicer also includes a first actuator to actuate the base plate in opposing directions and a second actuator to rotate the rotatable dish. The slicer may also include a blocking mechanism to limit an amount of rotation of the rotatable dish and a power source to drive the slicing mechanism. In operation, the base plate directs the bakery product into a cutting path of the slicing mechanism to form a cut in the bakery product. Thereafter, the rotatable dish is rotated a predetermined amount, and the base plate is moved in an opposite direction so that the slicing mechanism forms another cut in the bakery product. The rotatable dish may be rotated and the process repeated to form any number of bakery product slices.

### FIELD OF INVENTION

The present invention relates to the bakery or confectionery industry. More specifically, the present invention relates to an automated slicer for circular formed bakery products and method of use.

### BACKGROUND OF INVENTION

Generally, large circular-shaped bakery products are divided into multiple radial slices before becoming available to a final customer. However, in large production volumes, such as in large industries, dividing circular-shaped bakery products into multiple radial slices is a labor-intensive operation, because the operation was performed manually by hand.

To improve the efficiency and speed of the slicing operation, electric knives and slicers (dividers) have been used. However, such methods are insufficient. Additionally, hand slicing is insufficient because hand slicing detrimentally affects the quality of each slice that subsequently must be packed. Further, hand slicing usually causes damage to the circular-shaped bakery products, because hand slicing fails to completely sever the slices. Consequently, the slices are only partially detached causing the slices to be torn or ripped, which results in a poor appearance to the slices and lessens the slices' appeal.

Further, hand slicing of circular-shaped bakery products requires a large labor force, resulting in high production costs Also, hand slicing increases a risk of product contamination as well as damage to the bakery products caused by handling. Additionally, hand slicing does not produce heterogeneous slices of uniform size and weight.

### OBJECTIVES OF THE INVENTION

There is presently disclosed a bakery product slicer that may be used in a high production industrial application for slicing bakery products with a high production rate. The bakery product slicer increases productivity, operating speeds, and processing speeds while decreasing production costs.

Disclosed herein is a slicing machine operable to make radial cuts in circular-shaped bakery products in a fast, efficient, and automated manner.

The bakery product slicer also increases the processing efficiency by decreasing processing times and increasing production volumes.

The bakery product slicer eliminates the need for manual slicing and provides precise, quality cuts having an excellent appearance.

The bakery product slicer also reduces production costs.

The bakery product slicer is also practical, functional, durable, and requires little maintenance.

The bakery product slicer also produces homogeneous slices having a uniform shape, size, and weight.

The bakery product slicer has a reduced cutting time.

The bakery product slicer includes simple, accessible elements and is easily operated.

Other benefits and advantages will become apparent upon review of the detailed description with reference to the accompanying drawing.

### BRIEF DESCRIPTION OF THE INVENTION

A bakery product slicer includes a support structure that supports an upper shelf and a slideable base plate that is slideable along a longitudinal axis. The base plate supports a rotatable dish upon which a bakery product, such as a circular-shaped bakery product, is placed. The bakery product slicer also includes a slicing mechanism powered by a power source. The slicing mechanism is provided adjacent to the rotatable dish and forms cuts across the diameter the bakery product. The base plate is slideable back and forth on the support structure along the longitudinal axis to direct the bakery product, provided on the rotatable dish, into a cutting path of the slicing mechanism. According to one implementation, the base plate is actuated by a linear actuator, such as a pneumatic cylinder. During movement of the base plate in a first direction of the longitudinal axis, the rotatable dish is prevented from rotating while the bakery product is cut by the slicing mechanism. When the base plate reaches a point along the longitudinal direction, the rotatable dish is rotated a predetermined amount about the central axis by an actuator. The amount the rotatable dish may be rotated may be limited by a blocking mechanism. Once the rotatable dish is rotated, the base plate is directed along the longitudinal axis is an opposite direction to form another cut in the bakery product by the cutting mechanism. The operation may be repeated any number of times to divide the bakery product into any number of slices, such as radial slices, for example.

The blocking mechanism may be placed under the base plate and may include physical blocks or any other structure that limits an amount of rotation of the base plate.

The base plate may be actuated by an actuator, such as a pneumatic cylinder, hydraulic cylinder, electromagnetic cylinder, or any other mechanism to slide the base plate.

The bakery product slicer may form any number of cuts in a bakery product to form a desired number of bakery product slices. For example, the bakery product slicer may perform six cuts. After each cut, the rotatable dish is rotated 30°. Consequently, the bakery product is cut into twelve uniform slices. Further, according to one implementation, a total operation time for forming the twelve slices is approximately fourteen seconds.

The bakery product slicer produces clean, precise cuts that are formed without ripping the bakery products. As a result, the slices formed by an operation of the bakery product slicer have a uniform size, shape, and weight and, therefore, have a high quality appearance.

According to one implementation, the slicing mechanism is a rotatable cutting disk that includes a central shaft connected to the power source. According to a further implementation, the slicing mechanism may include a revolving cutting band or any other cutting mechanism.

In one implementation, the power source is provided in a platform affixed to one side of the supporting structure.

The supporting structure may include an upper shelf having lateral guides that support the slideable base plate. The supporting structure may also include a longitudinal central channel that houses the actuator that actuates the base plate.

Additional aspects, advantages, and novel features of one or more implementations will be better understood as set forth in the following description and accompanying drawings and will also become apparent to those skilled in the art upon examination of the following or upon learning by practice of the invention.

### BRIEF DESCRIPTION OF DRAWINGS

The features of the various implementations will be more readily understood with reference to the following description and the attached drawings, wherein

FIG. 1 is a perspective view of a bakery product slicer, according to one implementation.

The accompanying drawing is merely illustrative and is not meant to be limiting.

### DETAILED DESCRIPTION OF THE INVENTION

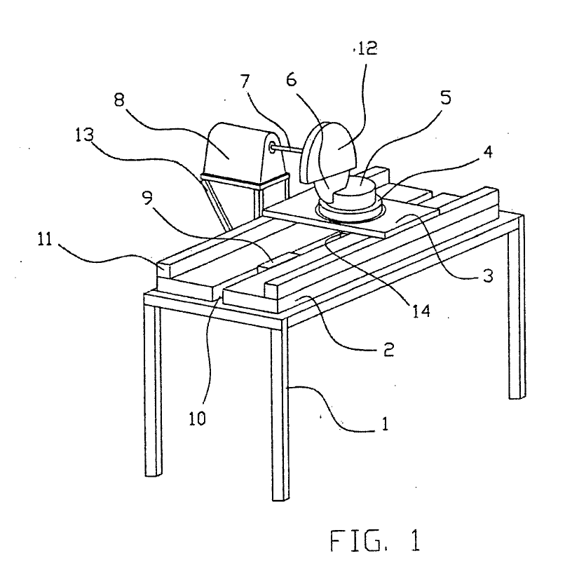

FIG. 1 shows a view of a bakery product slicer having a support structure 1 that supports an upper shelf 2 and a slideable base plate 3 that is slideable along a longitudinal axis of the shelf. The base plate 3 supports a rotatable dish 4 upon which a bakery product 5, such as a circular-shaped bakery product is placed. The bakery product slicer also includes a slicing mechanism 6 provided adjacent to the rotatable dish 4. The slicing mechanism 6 includes a central shaft 7 that is connected to a power source 8. The slicing mechanism 6 forms cuts, such as, for example, diameter cuts, in the bakery products 5 disposed on the rotatable dish 4.

An actuator 9, such as a pneumatic cylinder, is provided in a longitudinal central channel 10 formed in the upper shelf 2. The actuator 9 is operable to slide the base plate 3 in opposite directions along the longitudinal axis to direct the bakery product 5 into a cutting path of the slicing mechanism 6. When the base plate 3 is moved so as to form a cut in the bakery product 5 via the slicing mechanism 6, the rotatable dish 4 is maintained stationary relative to the base plate 3 until the base plate reaches a predetermined position along the longitudinal axis. For example, the rotatable dish 4 remains stationary until the slicing mechanism 6 has fully passed through the bakery product 5. Thereafter, at the end of the longitudinal run, the bakery product 5 is rotated by rotating the rotatable dish 4 a desired amount. In one implement, the rotatable dish 4 is rotated by a piston 14 fastened to a lower part of the rotatable dish 4. A blocking mechanism (not showed) may be used to limit an amount by which the rotatable dish 4 may be rotated. Further, the blocking mechanism may be placed under the base plate 3. Once the bakery product 5 is rotated to another position, the base plate 3 is advanced in an opposite direction along the longitudinal axis such that the slicing mechanism 6 forms another cut through the bakery product 5. This operation may be repeated any desired number of times to form any number of slices of the bakery product 5.

The upper shelf 2 may also include lateral guides 11. The lateral guides 11 provide a sliding surface for the base plate 3 as it moves longitudinally on shaft 2.

According to one implementation, the slicing mechanism 6 includes a rotating cutting disk with a protection cover 12. The power source 8 may be supported on a platform 13 affixed to a side of the support structure 1.

Implementations have now been sufficiently described to enable one skilled in the art to reproduce and obtain the results described herein. Additionally, it will be understood that various modifications may be made without departing from the spirit and scope of the invention. Accordingly, other implementations are within the scope of the following claims.

1-5. (canceled)

6. A bakery product slicer comprising:
a supporting structure;
a base plate slideable relative to the supporting structure;
a rotatable dish provided on the base plate and rotatable thereon; and
a slicing mechanism disposed above the rotatable dish, said slicing mechanism operable to slice a bakery product provided on the rotatable dish.

7. The bakery product slicer according to claim 6 further comprising a first actuator operable to move the base plate relative to the supporting structure.

8. The bakery product slicer according to claim 7, wherein the first actuator is one selected from the group consisting of a pneumatic cylinder, a hydraulic cylinder, and an electromagnetic cylinder.

9. The bakery product slicer according to claim 7, wherein the first actuator is a mechanism operable to slide the base plate in opposing longitudinal directions.

10. The bakery product slicer according to claim 6, wherein the base plate is slideable in first and second opposing longitudinal directions.

11. The bakery product slicer according to claim 6 further comprising a second actuator operable to revolve the rotatable dish a predetermined amount of rotation.

12. The bakery product slicer according to claim 6 further comprising a power source coupled to the slicing mechanism to drive the slicing mechanism.

13. The bakery product slicer according to claim 12, wherein the power source and the slicing mechanism are coupled via a shaft extending between the engine and the slicing mechanism.

14. The bakery product slicer according to claim 13, wherein the slicing mechanism is a rotatable blade.

15. The bakery product slicer according to claim 6 further comprising a blocking mechanism operable to limit an amount of rotation of the rotatable dish.

16. The bakery product slicer according to claim 6 further comprising lateral guides provided on the support structure wherein the base plate is slideable on the longitudinal guides.

17. The The bakery product slicer according to claim 6 further comprising a longitudinal channel provided on the supporting structure wherein the first actuator is at least partially disposed in the central longitudinal channel.

18. A method for forming radial slices in bakery products comprising:
(a) sliding a bakery product in a first longitudinal direction through a cutting path of a slicing mechanism and, thereby, forming a first cut through the bakery product;
(b) rotating the bakery product a predetermined amount; and
(c) sliding the bakery product in a second longitudinal direction, opposite the first longitudinal direction, through the cutting path of the slicing mechanism and, thereby, forming a second cut through the bakery product.

19. The method according to claim 18 further comprising:
(d) rotating the bakery product a predetermined amount;
(e) sliding the bakery product in the first longitudinal direction through the cutting path and, thereby, forming a third cut;
(f) rotating the bakery product a predetermined amount; and
(g) sliding the bakery product in the second longitudinal direction, opposite the first longitudinal direction, through the cutting path of the slicing mechanism and, thereby, forming a fourth cut through the bakery product.

20. The method according to claim 10 further comprising repeating steps (a) through (g) any desired number of times to form any desired number of cuts through the bakery product.

21. A method for forming radial slices in bakery products comprising:
(a) placing a bakery product on a rotatable dish provided on a base plate, wherein the rotatable dish is rotatable relative to the base plate;
(b) actuating a first actuator to slide the base plate in a first longitudinal direction, wherein the bakery product is directed through a cutting path of a slicing mechanism, thereby forming a radial slice through the bakery product;
(c) actuating a second actuator to rotate the rotatable dish a predetermined amount; and
(d) actuating the first actuator to slide the base plate in a second longitudinal direction, opposite the first longitudinal direction, wherein the bakery product is directed through the cutting path of the slicing mechanism, thereby, forming a second cut through the bakery product.

22. The method according to claim 21 further comprising:
(e) revolving the rotatable dish a predetermined amount.

23. The method according to claim 22 further comprising repeating steps (a) through (g) any desired number of times to form any desired number of cuts through the bakery product.

24. The method according to claim 21, further comprising engaging the rotating dish with a blocking mechanism to stop the rotation of the rotatable dish at a predetermined amount of rotation.

25. The method according to claim 21, wherein the bakery product is a circular-shaped bakery product.
